(19) United States
(12) Patent Application Publication
(10) Pub. No.: US 2011/0129757 A1
(43) Pub. Date: Jun. 2, 2011

(54) FUEL CELL WITH MEMBRANE/ELECTRODE STACK PERPENDICULAR TO THE SUPPORT SUBSTRATE AND METHOD FOR PRODUCING

(75) Inventors: Bernard Diem, Echirolles (FR); Philippe Baclet, Coublevie (FR); Jean Dijon, Champagnier (FR); Jean-Yves Laurent, Domene (FR); Pascal Schott, Villard de Lans (FR)

(73) Assignee: COMMISSARIAT A L'ENERGIE ATOMIQUE ET AUX ENERGIES ALTERNATIVES, Paris (FR)

(21) Appl. No.: 12/993,609

(22) PCT Filed: May 7, 2009
(86) PCT No.: PCT/FR2009/000540

§ 371 Date: Jan. 28, 2011

(30) Foreign Application Priority Data
May 19, 2008 (FR) 08 02681

(51) Int. Cl. H01M 8/10; H01M 8/00; H01M 8/24; B82Y 30/00

(52) U.S. Cl. 429/465; 429/535; 977/762

(57) ABSTRACT

A fuel cell includes at least one stack the main elements whereof are perpendicular to a support substrate. This stack is provided with an electrolytic membrane situated between a first and second electrode. The first and second electrodes each include a catalytic layer in contact with the electrolytic membrane. Each electrode includes an electrically conductive porous diffusion layer, and each stack is inserted between electrically conductive first and second support partitions perpendicular to the support substrate and constituting current collectors of the stack. The support partitions are electrically insulated from one another.

### BACKGROUND OF THE INVENTION

The invention relates to a fuel cell comprising at least one stack provided with an electrolytic membrane situated between a first electrode and a second electrode perpendicular to a support substrate, said first and second electrodes each comprising a catalytic layer in contact with the electrolytic membrane.

### STATE OF THE ART

U.S. Pat. No. 6,312,846 describes a fuel cell, illustrated in FIG. 1, made in a support substrate 1, preferably made from silicon. Support substrate 1 is first of all etched so as to form a trench 2 comprising a base 3 joining two opposite side walls 4a and 4b. A stack 5 constituting the fuel cell is then produced on base 3 of the trench perpendicularly to the substrate 1 (the main elements of the stack are arranged side by side along the substrate and perpendicular to the substrate). The stack comprises an electrolytic membrane 6 situated between two electrodes each comprising a catalytic layer 7 perpendicular to base 3 and connected to current collectors 14. The height of stack 5 is substantially equal to the depth of trench 2. The fuel cell comprises two injection channels 8a and 8b delineated by the space left free on each side of stack 5 between stack 5 and side walls 4a and 4b. First channel 8a is designed for flow of a fuel fluid, for example hydrogen, whereas second channel 8b is designed for flow of an oxidant fluid, for example oxygen or air. Trench 2 is then covered by a cover 9 equipped with an adhesive layer 10 and hermetically closing injection channels 8a and 8b.

According to another embodiment illustrated in FIG. 2, U.S. Pat. No. 6,312,846 describes a stack, made in a trench 2, the membrane whereof (not shown) is arranged between two intermediate walls 11a and 11b. A space, arranged on each side of intermediate walls 11a and 11b, forms injection channels 8a and 8b. Intermediate walls 11a and 11b each comprise a plurality of slits 12. The electrodes each comprise a metal part 13, situated at the outer base of the corresponding intermediate wall, and a catalyst 7 deposited at the level of slits 12 and in contact with metal part 13 which it partially covers. Metal parts 13 of the electrodes are connected to metal conductors acting as current collectors 14. Catalyst 7 forms a bridge, called reaction-source triple point, where the electrolytic membrane, catalytic layer 7 and one of the fluids (fuel or oxidant) are in contact. This reaction-source triple point has a surface limited to the sum of the surfaces of slits 12 of walls 11a and 11b. The active surface yield efficiency is therefore limited to the surface of slits 12 for each wall. The electric conduction is further limited to current collectors 14 only, giving rise to a high ohmic loss at the level of catalytic layers 7. The isolation between electrodes by the support material, in which the trench is made, is moreover not of good quality.

### OBJECT OF THE INVENTION

The object of the invention consists in producing a fuel cell the power density whereof is optimized and the ohmic loss whereof is reduced.

This object is achieved by the fact that each electrode comprises an electrically conductive porous diffusion layer, and that each stack is inserted between first and second electrically conductive support partitions perpendicular to the support substrate and forming current collectors of the stack, said support partitions being electrically insulated from one another.

According to an alternative embodiment, the fuel cell comprises a plurality of stacks side by side, two adjacent stacks comprising a common partition, terminals of the cell being connected to the partitions situated at the ends of the plurality of stacks.

According to a first embodiment, the fuel cell comprises at least two superposed stacks, an electrically insulating layer arranged between the support substrate and the corresponding stack, comprising passages for a fluid between the diffusion layers of two superposed stacks.

According to a second preferred embodiment, each partition separating two adjacent stacks comprises a fluid injection channel comprising two walls perpendicular to the support substrate and each provided with a plurality of through holes for injection of one and the same fluid into the adjacent diffusion layers separated by said partition.

The invention also relates to a method for producing a fuel cell comprising the following successive steps:
transfer of a plate made from a material forming the support partitions onto the support substrate, electric interconnection means being arranged on the plate and/or the support substrate,
etching of the partitions in the plate,
deposition of the diffusion layers and catalytic layers on the partitions by electrodeposition with polarization of the partitions by means of the electric interconnection means.

### BRIEF DESCRIPTION OF THE DRAWINGS

Other advantages and features will become more clearly apparent from the following description of particular embodiments of the invention given for non-restrictive example purposes only and represented in the appended drawings, in which:

FIG. 1 illustrates a cross-sectional view of a fuel cell according to the prior art.

FIG. 2 illustrates a perspective view of another fuel cell according to the prior art.

FIG. 3 schematically illustrates a cross-sectional view of a stack according to the invention.

FIG. 4 schematically illustrates a cross-sectional view of a plurality of stacks according to an alternative embodiment of the invention.

FIG. 5 illustrates a cross-sectional view of a first embodiment of the invention.

FIG. 6 illustrates a cross-sectional view of a variant of the first embodiment of FIG. 5.

FIGS. 7 to 9 illustrate, in cross-section, different steps of a production method according to the first embodiment.

FIG. 10 illustrates a second embodiment the invention, in cross-section.

FIG. 11 illustrates a variant of the second embodiment, in top view.

FIG. 12 illustrates a cross-section along the line A-A of FIG. 10.

FIGS. 13 to 14 illustrate, in cross-section, different steps of a production method according to the second embodiment.

FIGS. 15 and 16 illustrate two variants of electric connection of the second embodiment.

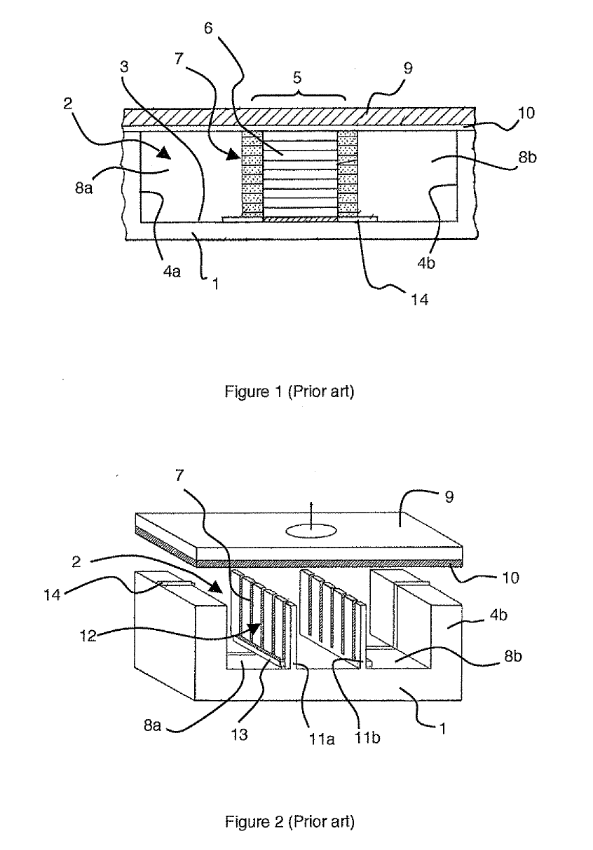

### DESCRIPTION OF A PREFERRED EMBODIMENT OF THE INVENTION

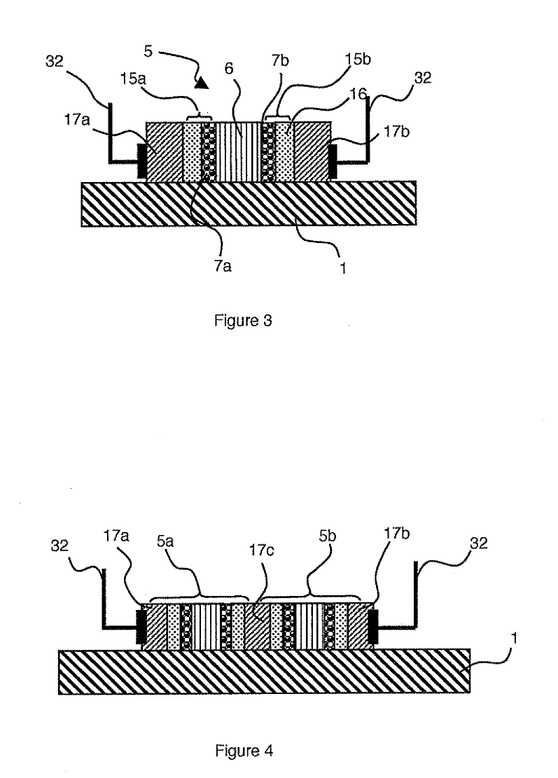

As illustrated in FIG. 3, a fuel cell comprises at least one stack 5 substantially perpendicular to support substrate 1. Stack 5 is, in conventional manner, provided with an electrolytic membrane 6 situated between first and second electrodes 15a and 15b perpendicular to substrate 1. The first and second electrodes each comprise a catalytic layer 7a, 7b in contact with electrolytic membrane 6. Such a stack 5 enables electricity to be produced by means of oxidation on first electrode 15a of a fuel fluid, for example hydrogen, coupled with reduction on second electrode 15b of an oxidant, for example the oxygen of the air.

Each electrode 15a and 15b comprises an electrically conductive porous diffusion layer 16. Each stack 5 is inserted between first and second electrically conductive support partitions 17a and 17b perpendicular to support substrate 1. A diffusion porous layer 16 of each electrode is in electric contact with both catalytic layer 7a or 7b of the corresponding electrode and with corresponding partition 17a or 17b. Partitions 17a and 17b thus serve the purpose both of support for stack 5 and of current collectors connected to terminals 32 of the fuel cell.

Support partitions 17a, 17b are electrically insulated from one another. This electric insulation of partitions 17a, 17b is for example achieved by support substrate 1, 25, itself electrically insulated, or by an insulating layer 20 arranged between support substrate 1, 25 and stack 5. The active surface corresponding to the whole surface of the partitions being larger than in known fuel cells, the global power of the cell is improved. The support partitions are electrically insulated from one another.

Each porous diffusion layer 16 can advantageously be made from a base comprising nanotubes or nanowires. The nanotubes or nanowires are then substantially parallel to support substrate 1 and connect catalytic layer 7a or 7b of the electrode to corresponding partition 17a or 17b. The use of nanotubes or nanowires ensures efficient diffusion of the fluids (fuel and oxidant) to catalytic layer 7a or 7b, a good thermal and electric conduction, and limits certain stresses that may occur when swelling of electrolytic membrane 6 takes place, in particular when the latter is made from Nafion©.

The nanowires or nanotubes forming porous diffusion layers 16 are preferably made from carbon. Carbon, presenting the advantage of being conductive, enables the nanowires or nanotubes to electrically connect partition 17a or 17b to corresponding catalytic layer 7a or 7b. The nanowires or nanotubes can be produced by deposition of a growth catalyst, chosen from iron, cobalt or nickel, on the inner side wall of each partition 17a or 17b. Deposition of this catalyst can be performed by electrochemical deposition or by PVD. Growth of the nanotubes or nanowires preferably takes place between 550° C. and 600° C. with acetylene. The length of the nanotubes or nanowires corresponds to the width of porous diffusion layer 16, typically between 30 μm and 100 μm, obtained in about 30 minutes growth. Such a patterning of porous diffusion layer 16 ensures efficient diffusion of the fluids to catalytic layers 7a and 7b of each stack.

According to an alternative embodiment, porous diffusion layers 16 can be made from porous semiconductor material using for example silicon plates having been subjected to anodization in the presence of HF, graphite, ceramic Al or any other material able to locally acquire a certain porosity for the fluids.

Catalytic layers 7 of first and second electrodes 17a, 17b can be of different nature and/or structure.

As illustrated in FIG. 4, a fuel cell can comprise a plurality of stacks (5a and 5b in FIG. 4) made side by side on the same support substrate 1 so as to increase the power density with respect to the surface of the fuel cell and to limit ohmic losses when stacks 5 are electrically connected to one another. Two adjacent stacks 5a and 5b are then separated by an intermediate partition 17c which replaces partition 17b of stack 5a and partition 17a of stack 5b (FIG. 3), this electrically conductive partition 17c electrically connecting the electrodes of two adjacent stacks. Terminals 32 of the fuel cell are then connected to partitions 17a and 17b situated at the ends of the plurality of stacks.

The plurality of stacks made on the same support substrate thereby constitutes a multipolar plate. The stacks are then electrically connected to one another in series. Series connection implies constraints on flow of the fluids in the stacks.

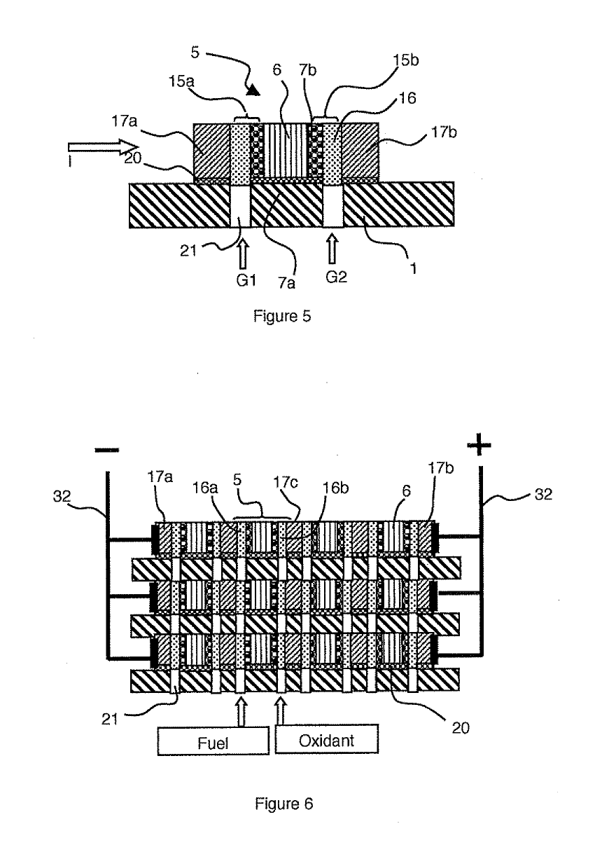

According to a first particular embodiment illustrated in FIG. 5, passages 21 formed in support substrate 1 of at least one stack 5, perpendicular to support substrate 1, enable the fluid s to flow perpendicularly to support substrate 1 (arrows G1 and G2) whereas the current flows parallel to support substrate 1 (arrow I). An electrically insulating layer 20 is arranged between support substrate 1, partitions 17a, 17b and the corresponding stack in the case where the substrate is not insulating.

In the alternative embodiment of FIG. 6, several multipolar plates are superposed. Support substrate 1 of each multipolar plate then comprises passages 21 for the fluids (fuel and oxidant) between porous diffusion layers 16a, 16b of two superposed stacks 5.

Assembly of several multipolar plates by superposing the stacks of two successive plates enables different electric assemblies to be formed. For example an assembly called “filter press” is illustrated in FIG. 6. As in FIG. 4, two diffusion layers of two adjacent stacks of a multipolar plate are separated by an intermediate partition 17c. As in FIG. 5, the fuel fluid, for example hydrogen, flows in a first diffusion layer 16a and the oxidant fluid, for example the oxygen of the air, flows in a second diffusion layer 16b of each stack. End partitions 17a and 17b of the superposed multipolar plates are then connected in parallel respectively to two terminals 32. Such a series/parallel connection enables the voltage in the fuel cell to be increased.

Superposition of a plurality of multipolar plates naturally enables numerous other electric connection variants to be achieved. For example the multipolar plates can all be connected in series to the terminals of the cell, connected in parallel two by two, and the pairs formed in this way be connected in series to the terminals of the fuel cell, etc.

Two superposed multipolar plates are advantageously separated by a seal providing tightness 19 (FIG. 9). Seal 19 is perforated at the level of porous diffusion layers 16, thereby enabling the fluids to pass from a bottom stack to a top stack (or vice-versa) perpendicularly to support substrate 1.

The first embodiment can in particular be implemented by techniques derived from microelectronics based on technologies of CMOS super-capacitance type or on microtechnologies.

For example purposes, the fuel cell can be produced using photovoltaic silicon plates the cost of which is today relatively low, and by making a porous material therefrom, the dimensioning of the pores being preferably comprised between 20 nm and 200 nm. Macroscopic distribution channels can also be achieved by piercing the plates on the back surface to facilitate diffusion of the fluids in the electrodes. The porous diffusion layers can be rendered electrically conductive by Atomic Layer Deposition (ALD) of titanium. Such a deposition in diffusion layers 16 enables the quantity of titanium and therefore the cost to be minimized. The catalytic layers can be made from platinum, the surface in contact with the membrane being able to be nano-patterned to improve the exchange surface.

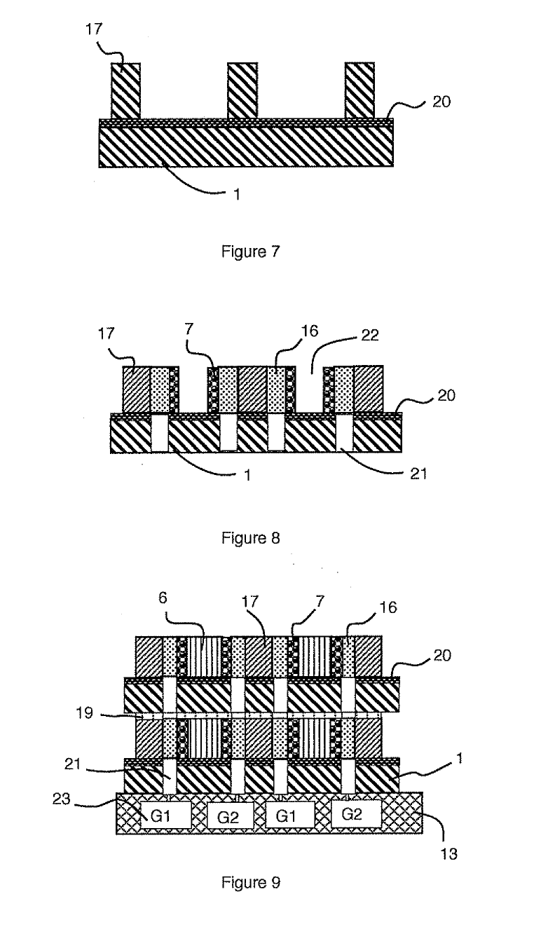

FIGS. 7 to 9 illustrate a method for producing according to the first embodiment. The method comprises the following successive steps performed on a substrate 1, preferably a silicon substrate, comprising a buried insulating layer 20:
localization of the stacks by etching the substrate with etch stop on buried insulating layer 20 (FIG. 7) to form partitions 17. Etching can be performed by reactive ion etching (RIE) or by chemical etching (KOH). The part of the initial silicon substrate located under the buried insulating layer then forms support substrate 1.
making passages 21 in support substrate 1 and insulating layer 20 for flow of a fluid of fuel or oxidant type, such as hydrogen and oxygen, in the diffusion layers. These passages 21 can be made by deep reactive ion etching of support substrate (FIG. 8) or by rendering the support substrate locally porous at the location of the passages.
doping silicon support partitions 17 (FIG. 8) to make them electrically conductive, for example by ion implantation.
making diffusion layers 16 (FIG. 8), for example by electrodeposition or by growth of nanowires or nanotubes substantially parallel to support substrate 1, after deposition, for example by PVD, of a catalyst layer, for example made from iron, on the inner walls of partitions 17.
deposition of catalytic layers 7 of each stack, for example by PECVD deposition of platinum or by electrodeposition.
filling cavities 22 formed by the free space remaining between the electrodes of each stack to form electrolytic membranes 6. Cavities 22 can for example be filled by inkjet by a solution of Nafion© base.
sealing off cavities 22 by deposition of a polymer film. The polymer film is preferably deposited on the stacks, then perforated facing diffusion layers 16. The polymer film can also form tightness seal 19 enabling superposition of several plates.

Such an embodiment enables the electric conduction and tightness functions to be separated, while at the same time making the cell easier to assemble. Furthermore, series connection of the stacks arranged on the same level is performed automatically during fabrication thereby enabling optimization and reduction of ohmic losses. As illustrated in FIG. 9, a fluidic plate 13 can be added at least on one side of the superposition of multipolar plates. Fluidic plate 13 comprises distribution and fluid recovery channels 23 connected to passages 21.

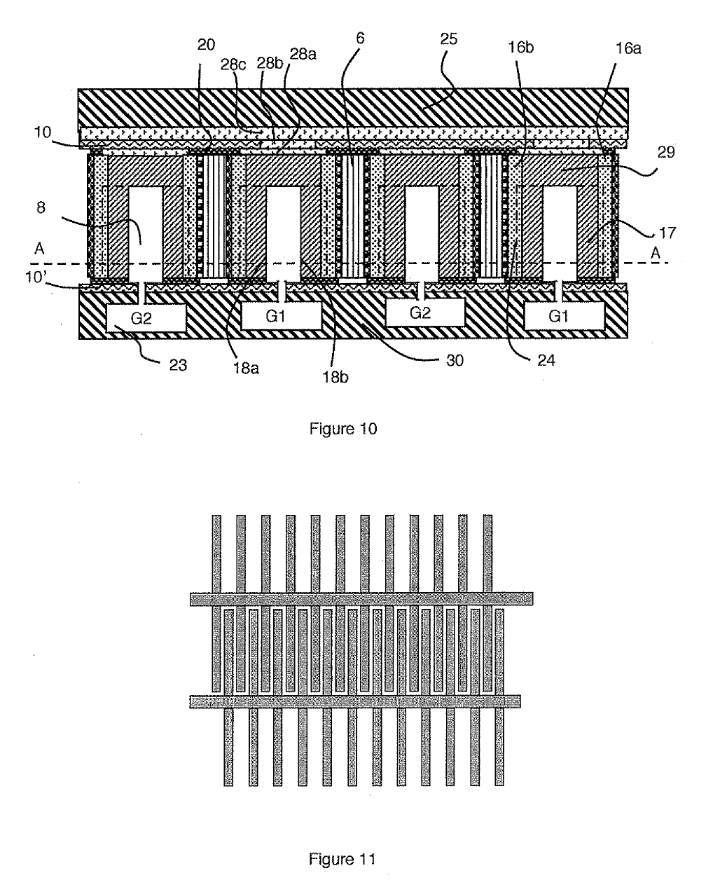

According to a second embodiment illustrated in FIG. 10, each partition 17 separating two adjacent stacks arranged on the same level comprises a fluid injection channel 8. Injection channel 8 comprises two side walls 18 (18a and 18b in FIG. 10) substantially perpendicular to support substrate 25. Each of walls 18 comprises (FIG. 12) a plurality of through holes 24 for injection of one and the same fluid into two adjacent diffusion layers 16 (16a and 16b) separated by partition 17 from one and the same injection channel. Holes 24 make the connection between injection channel 8 and diffusion layers 16. The number of holes 24 of each wall 18a, 18b is preferably optimized so as to obtain a trade-off between strength of partitions 17, electric conduction and effective fluid exchange surface between injection channel 8 and diffusion layers 16a, 16b.

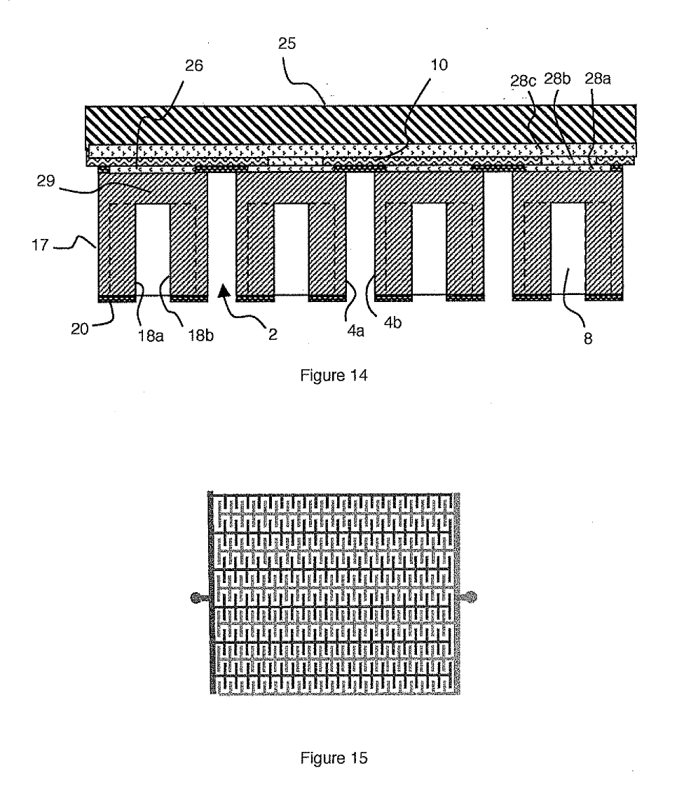

The stacks can be sandwiched between two horizontal plates so as to form an elementary assembly. A plurality of stacks are fixed side by side to a first plate 25, acting as support substrate, by an adhesive layer 10 or by any other assembly technique. plate 25 serves the purpose of mechanical fixing for the vertical partitions 17 and makes the electric interconnections via metalization layers 28 (28a, 28b, 28c in FIGS. 10 and 14). The plate also performs the electrical insulations between the different stacks. This first plate 25 is preferably made from a silicon substrate.

A second plate 30 comprises distribution and gas recovery channels 23. Distribution channels 23 are connected to injection channels 8. Second plate 30 can be fixed to the stacks by means of an adhesive additive 10′ or by any other suitable assembly technique such as wafer bonding, eutectic bonding, anodic bonding, etc.

According to an alternative embodiment (not shown), the power of the cell can be increased by superposing several elementary assemblies. In this case a plate separating two adjacent elementary assemblies can integrate both the electric interconnections and the fluid distribution and recovery channels on each surface. The fuel cell thus comprises at least one superposed bottom stack and top stack, the support substrate of the bottom stack comprising distribution channels then forming the distribution plate of the top stack.

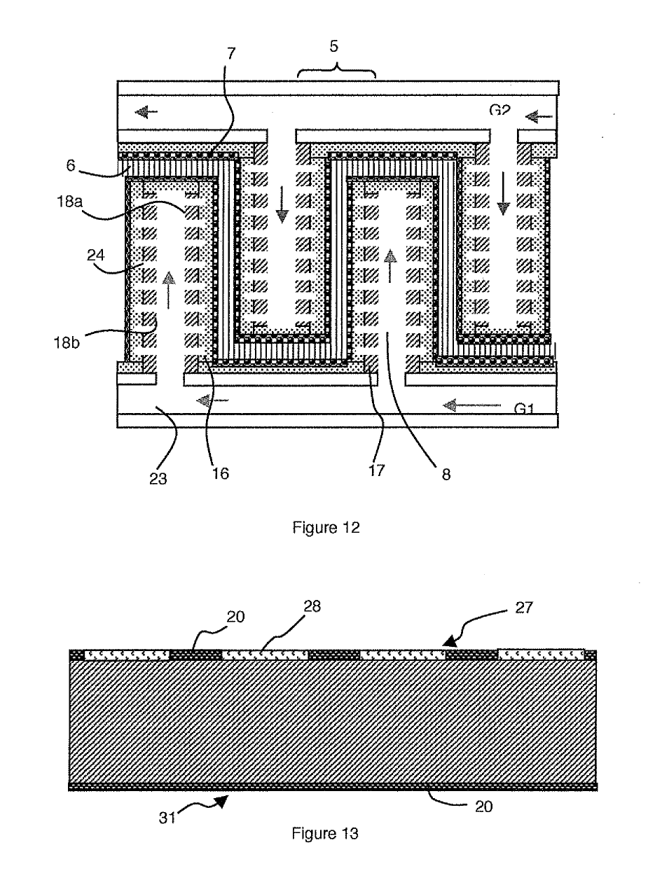

Preferably, as illustrated in FIGS. 11 and 12, arrangement of the stacks is interdigital. This arrangement enables a maximum filling coefficient and an electric interconnection of series/parallel type to be obtained. In order to achieve such an arrangement, electrolytic membranes 6 of adjacent stacks 5, perpendicular to support substrate 25, are formed by segments, vertical in FIG. 12, joined to one another by horizontal segments in FIG. 12 so as to constitute a continuous membrane 6 in the form of crenelations. A continuous assembly designed to form electrodes 15 is constituted by a diffusion layer 16 on which a catalytic layer 7 is formed, this assembly being arranged on each side of membrane 6. A vertical partition 17 comprising an injection channel 8 is arranged between two vertical segments (membrane 6, layer 7 and layer 16), two adjacent vertical diffusion layers 16 arranged on each side of partition 17 being located on the same side of continuous membrane 6.

The metal connections of the fuel cell are preferably in the form of interdigital combs (FIGS. 11 and 12). A comb is connected to the adjacent partitions located on the same side of membrane 6, then corresponding to the same type of electrode.

A fuel cell of this type is achieved by:
transfer of a plate made from a material constituting support partitions 17a, 17b onto support substrate 25, electric interconnection means 28a, 28b, 28c being located on the plate and/or support substrate 25,
etching of the partitions in the plate,
deposition of diffusion layers 16 and catalytic layers 7 on the partitions by electrodeposition or electrochemical deposition ECD, with polarization of the partitions via the electric interconnection means.

The electrolyte forming membrane 6 can subsequently be injected between catalytic layers 7 at the level of a cavity delineated by catalytic layers 7.

FIGS. 13, 14 and 10 illustrate the production method of the second embodiment in greater detail. The method comprises the following successive steps performed from an initial substrate, preferably a highly-doped single-crystal, poly-crystal or multi-crystal silicon substrate, constituting the plate made from material forming the partitions:
deposition of an insulating layer 20 on the two opposite surfaces of the initial substrate (FIG. 13). This deposition can have a thickness of 0.3 μm and be formed by silicon nitride deposited by LPCVD or PECVD.
openings are made on a first surface 27 of the substrate by conventional masking and etching techniques to locally remove insulating layer 20 and make the substrate accessible. These openings are made at the locations of the future partitions 17,
deposition of a first metalization layer 28a of electrically conductive. material, for example gold, copper or aluminum at the level of the openings. The thickness of metalization layer 28a has to be sufficient to enable transportation of the current while minimizing resistive losses. It is in general a few micrometers,
securing first plate 25, acting as support substrate, on first surface 27 to perform the electric interconnection and mechanical support functions of stacks 5 for the remainder of the production process. Before it is secured, first plate 25 is provided with at least a second metalization layer (28b, 28c) etched so as to form the interconnections coming into contact with metal parts 28a. Plate 25 can be made from glass, SiN, or stainless steel. In the case where plate 25 is not electrically insulating, an electric insulation layer (not shown) is inserted between plate 25 and metal layer 28b, 28c.
etching of the initial substrate from its second surface 31 over the whole thickness (about 400 to 700 μm) of the initial substrate. This etching delineates (FIG. 14) partitions 17 and the locations of the stacks by formation of a trench 2 comprising two side walls 4a and 4b facing one another at the level of each stack 5. For example, each trench has a thickness of about 6 μm, two trenches being separated by about 25 μm.
making diffusion layers 16 on side walls 4a and 4b of each trench 2. These diffusion layers 16 are preferably achieved by localized anodization of the silicon in a hydrofluoric acid solution, application of an anodization voltage being possible due to metalization layers 28a, 28b, 28c able to act as electrodes, or by growth of nanowires or nanotubes on side walls 4a and 4b.
deposition of catalytic layers 7, preferably made from platinum, by electrodeposition or electrochemical deposition localized on diffusion layers 16a and 16b. Localization is possible due to polarization via metalization layers 28a, 28b, 28c, and it is therefore possible to produce first and second electrodes of different nature and/or structure for example by depositing a different thickness of layer depending on whether the first or second electrode is involved.
filling trenches 2 by electrolyte to form electrolytic membrane 6. This electrolyte can be Nafion© based and deposited locally by inkjet. If necessary, this filling can be performed in several operations in order to obtain a solid membrane by evaporation of the solvent contained in the Nafion©. Filling can also be performed in global manner at the end of the process by injection.
making injection channels 8 and holes 24 in each partition 17. These channels are preferably produced by etching. Etching is stopped so as to preserve a full bottom of partition 29, the thickness of which is preferably about 50 μm, thereby ensuring electric conduction and mechanical resilience of the whole.

The dimension of injection channels 8, and therefore the dimension of partitions 17, can differ according to the fluid and the geometry be adapted according to the required flow. In particular, oxygen or air requires a larger flow than hydrogen. Holes 24 in contact with the porous diffusion layers enable diffusion of the fluids over the whole active surface while preserving a sufficient mechanical resilience.

A second plate 30 is then added to second surface 31 of the initial substrate, performing tight sealing of both trenches 2 and injection channels 8. This second plate 30 comprises the network of distribution channels 23 of two different fluids. Etching of distribution channels 23 is advantageously performed by deep reactive ion etching (DRIE). As the geometry of these channels may be large, forming by stamping can be envisaged. Cooling channels (not shown) can be made in second plate 30. The role of such channels is to perform the function of cooling the fuel cell.

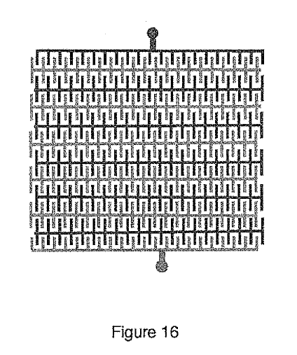

The arrangement in the form of a comb makes for versatility at the level of the electric connections according to the required output voltage. FIGS. 15 and 16 respectively illustrate an example of bipolar interconnection where all the stacks are connected in parallel and a multipolar interconnection where all the stacks are connected in series/parallel form.

1-16. (canceled)

17. A fuel cell comprising at least one stack provided with an electrolytic membrane situated between a first electrode and a second electrode perpendicular to a support substrate, said first and second electrodes each comprising a catalytic layer in contact with the electrolytic membrane, a cell wherein each electrode comprises a porous fluid feed diffusion layer, said diffusion layer being electrically conductive and separated from the membrane by the associated catalytic layer, and wherein each stack is sandwiched between electrically conductive first and second support partitions perpendicular to the support substrate and constituting current collectors of the stack, said support partitions being electrically insulated from one another.

18. The fuel cell according to claim 17, wherein the support partitions are insulated from one another by an insulating layer arranged between the support substrate and the corresponding stack.

19. The fuel cell according to claim 17, wherein the support substrate is made from electrically insulating material.

20. The fuel cell according to claim 17, wherein the diffusion layer of each electrode comprises a plurality of nanowires or nanotubes substantially parallel to the support substrate and joining the catalytic layer of the electrode to the corresponding partition.

21. The fuel cell according to claim 17, wherein the diffusion layer is made from porous silicon.

22. The fuel cell according to claim 17, wherein the catalytic layers of the first and second electrodes are of different nature and/or structure.

23. The fuel cell according to claim 17, comprising a plurality of stacks arranged side by side, two adjacent stacks comprising a common partition, terminals of the cell being connected to the partitions situated at the ends of the plurality of stacks.

24. The fuel cell according to claim 17, comprising at least superposed two stacks, an electrically insulating layer arranged between the support substrate and the corresponding stack, comprising passages for a fluid between the diffusion layers of two superposed stacks.

25. The fuel cell according to claim 17, wherein each partition separating two adjacent stacks comprises an injection channel of a fluid comprising two walls perpendicular to the support substrate and each provided with a plurality of through holes for injection of one and the same fluid into the adjacent diffusion layers separated by said partition.

26. The fuel cell according to claim 25, comprising a distribution plate provided with distribution channels connected to the injection channels.

27. The fuel cell according to claim 25, wherein the electrolytic membranes of the adjacent stacks are formed by segments of a continuous membrane in the form of crenelations and perpendicular to the support substrate, an assembly constituted by a catalytic layer and a diffusion layer being arranged on each side of said continuous membrane, a partition being arranged between two segments perpendicular to the support substrate, two adjacent diffusion layers arranged on each side of a partition being arranged on the same side of the continuous membrane.

28. The fuel cell according to claim 27, comprising metal connections in the form of interdigital combs, a comb being connected to the partitions corresponding to one and the same type of electrode.

29. The fuel cell according to claim 28, wherein the metal connections are made in metalization layers arranged between the support substrate and the stacks.

30. The fuel cell according to claim 26, comprising at least one superposed bottom stack and top stack, the support substrate of the bottom stack comprising distribution channels and forming the distribution plate of the top stack.

31. A method for producing a fuel cell according to claim 25, comprising the following successive steps:
transfer of a plate made from a material forming the support partitions onto the support substrate, electric interconnection means being arranged on the plate and/or support substrate,
etching of the partitions in the plate,
deposition of the diffusion layers and catalytic layers on the partitions by electrodeposition, with polarization of the partitions by means of the electric interconnection means.

32. The method according to claim 31, wherein the electrolyte is injected between the catalytic layers.
